(19) United States
(12) Patent Application Publication
(10) Pub. No.: US 2025/0304100 A1
(43) Pub. Date: Oct. 2, 2025

(54) AUTOMATED VEHICLE SYSTEMS FOR INFRASTRUCTURE AND ENVIRONMENTAL MAPPING AND VEHICLE BEHAVIOR MODIFICATION

(71) Applicant: Torc Robotics, Inc., Blacksburg, VA (US)

(72) Inventors: William Davis, Blacksburg, VA (US); Joseph R. Fox-Rabinovitz, Blacksburg, VA (US)

(21) Appl. No.: 18/622,117

(22) Filed: Mar. 29, 2024

(51) Int. Cl. B60W 60/00; G06V 10/70; G06V 20/56

(52) U.S. Cl. CPC B60W 60/001; G06V 10/70; G06V 20/56; B60W 2420/403; B60W 2556/10; B60W 2556/40; B60W 2556/65

(57) ABSTRACT

A system for infrastructure and environmental mapping and automated vehicle behavior modification includes a plurality of sensors of an autonomous vehicle and an autonomy computing system. The sensors capture sensor data representing an environment in which the autonomous vehicle is operating. The processor receives, from the sensors, first sensor data representing the environment in which the autonomous vehicle is operating at a first time, the first sensor data including image or video data. The processor also detects a difference between the first sensor data and historical sensor data at a location within the environment, and, based on the detected difference, stores an incident record indexed to the location relative to a stored map of the environment. When one or more adjustment criteria associated with the location are satisfied, the processor initiates one or more remedial actions associated with operation of the autonomous vehicle within the environment.

### TECHNICAL FIELD

The field of the disclosure relates generally to operation of autonomous vehicles and, more specifically, to infrastructure and environmental mapping using autonomous vehicles and vehicle behavior modification resulting therefrom.

### BACKGROUND OF THE INVENTION

At least some known autonomous vehicles may implement four fundamental technologies in their autonomy software system: perception, localization, behaviors and planning, and motion control. Perception technologies enable an autonomous vehicle to sense and process its environment, to identify and classify objects, or groups of objects, in the environment, for example, pedestrians, vehicles, or debris. Behaviors and planning technologies determine how to move through the sensed environment to reach a planned destination, processing data representing the sensed environment and localization or mapping data to plan maneuvers and routes to reach the planned destination. Motion control technologies translate the output of behaviors and planning technologies into concrete commands to the vehicle. Localization or mapping technologies determine, based on the sensed environment, for example, where in the world, or on a map, the autonomous vehicle is. In many instances, localization technologies may use data received from sensors or various odometry information sources to generate an estimated vehicle location in the world.

However, localization technologies rely on data captured at some previous instant(s) in time. Changes in the environment can limit the utility of localization and mapping technologies. For example, where infrastructure has changed or different patterns of behavior have emerged, the routing of autonomous vehicles through such an environment may be less efficient than expected.

Accordingly, there exists a need for systems and methods for identifying changes in an environment or route of an autonomous vehicle, to improve the mapping, routing, and control of the autonomous vehicle in response to such changes.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed system for infrastructure and environmental mapping and automated vehicle behavior modification includes a plurality of sensors of an autonomous vehicle and an autonomy computing system. The plurality of sensors are configured to capture sensor data representing an environment in which the autonomous vehicle is operating. The autonomy computing system includes a processor and a memory. The processor is programmed to receive, from the plurality of sensors, first sensor data representing the environment in which the autonomous vehicle is operating at a first time, the first sensor data including image or video data. The processor is also programmed to detect a difference between the first sensor data and historical sensor data at a location within the environment, the historical sensor data captured within the environment over a preceding period of time, and, based on the detected difference, store, in the memory, an incident record indexed to the location relative to a stored map of the environment. The processor is further programmed to, when one or more adjustment criteria associated with the location are satisfied, initiate one or more remedial actions associated with operation of the autonomous vehicle within the environment.

In another aspect, the disclosed computer-implemented method for infrastructure and environmental mapping and autonomous vehicle behavior modification is implemented by an autonomy computing system of an autonomous vehicle. The autonomy system includes a processor and a memory. The method includes receiving, from a plurality of sensors of the autonomous vehicle, first sensor data representing the environment in which the autonomous vehicle is operating at a first time, the first sensor data including image or video data. The method also includes detecting a difference between the first sensor data and historical sensor data at a location within the environment, the historical sensor data captured within the environment over a preceding period of time and, based on the detected difference, storing, in the memory, an incident record indexed to the location relative to a stored map of the environment. The method further includes, when one or more adjustment criteria associated with the location are satisfied, initiating one or more remedial actions associated with operation of the autonomous vehicle within the environment.

In yet another aspect, the disclosed autonomous vehicle includes a plurality of sensors configured to capture sensor data representing an environment in which the autonomous vehicle is operating, and an autonomy computing system including a processor and a memory. The processor is programmed to receive, from the plurality of sensors, first sensor data representing the environment in which the autonomous vehicle is operating at a first time, the first sensor data including image or video data. The processor is also programmed to detect a difference between the first sensor data and historical sensor data at a location within the environment, the historical sensor data captured within the environment over a preceding period of time, and, based on the detected difference, store, in the memory, an incident record indexed to the location relative to a stored map of the environment. The processor is further programmed to, when one or more adjustment criteria associated with the location are satisfied, initiate one or more remedial actions associated with operation of the autonomous vehicle within the environment.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a simplified illustration of an autonomous vehicle in accordance with the present disclosure;

FIG. 2 is a schematic block diagram of the autonomous vehicle shown in FIG. 1;

FIGS. 3-5 depict example environments in which the autonomous vehicle of FIG. 1 operates to detect infrastructure and objects and map the environment;

FIG. 6 is a block diagram of an example computing device; and

FIG. 7 is a flow diagram of an example method of infrastructure and environmental mapping and vehicle behavior modification.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Autonomous vehicles can function as, among other things, advanced mobile perception and data aggregation platforms. The ability of these vehicles to navigate the world successfully can be enhanced using additional data collection regarding behaviors that might interfere with vehicle activity. Moreover, this data collection can contribute to improved maintenance of infrastructure, ecological research, and driver and pedestrian safety.

The present disclosure is directed to autonomous vehicles and control thereof, using sensor data collection and interpretation techniques that improve the integration of changing environments into image processing models, localization maps, and responsive routing. These techniques can facilitate, for example, improved infrastructure monitoring and detection (e.g., identifying broken street lights, downed power lines, broken pipelines, etc.), ecosystem monitoring (e.g., identifying wildlife in environments that include and exclude the road being travelled), and identifying and reacting to changes in human behavior (e.g., increased pedestrian density, population reaction to highways, etc.). Internal and external reporting actions can be initiated to impact real-world reactions to these identified events, including improved vehicle responsiveness as well as physical or behavioral adjustments (e.g., infrastructure repairs, increased signage or traffic enforcement).

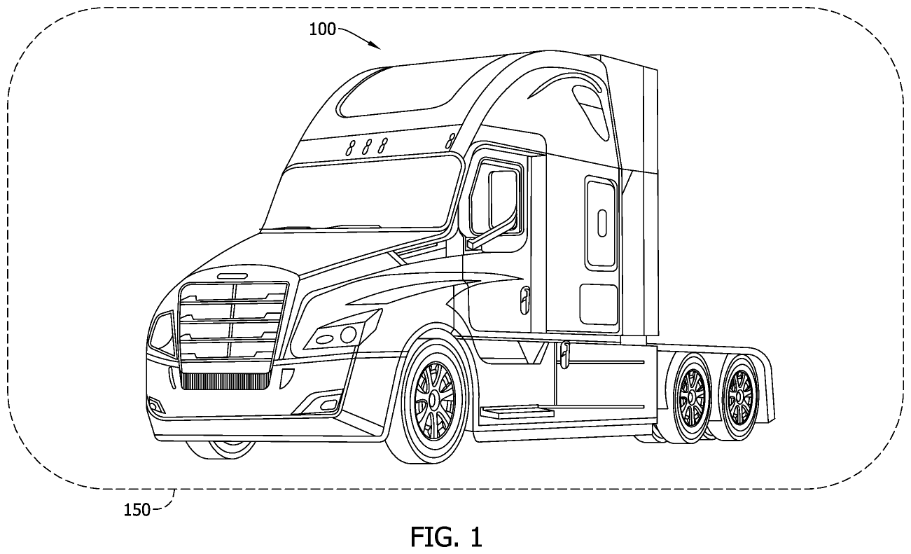

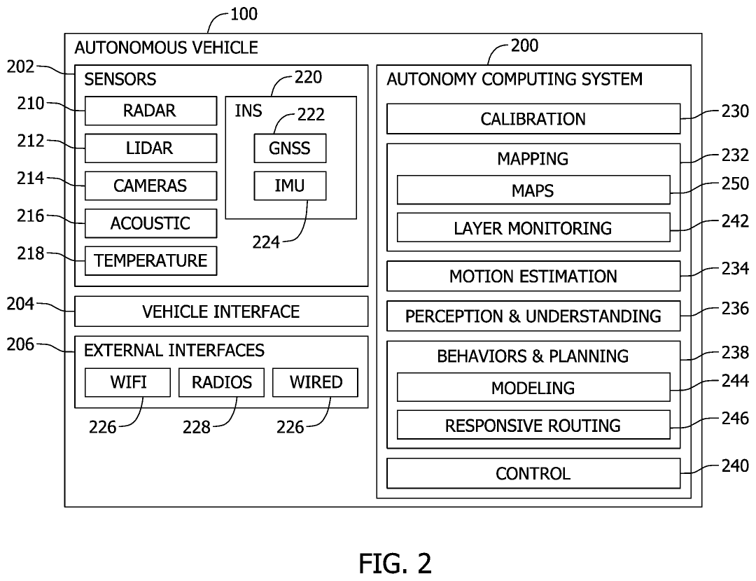

FIG. 1 is a simplified illustration of an autonomous vehicle 100, which operates under autonomous control in an environment 150. FIG. 2 is a schematic block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound) sensors, internal vehicle sensors, meteorological sensors, or other types of sensors. Sensors 202 generate respective output signals based on detected physical conditions of autonomous vehicle 100 and its proximity, including environment 150. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of environment 150 surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) in environment 150 around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, a layer monitoring module 242, a modelling module 244, and a responsive routing module 246. Layer monitoring module 242, for example, may be embodied within another module, such as mapping module 232, or separately. Likewise, modelling module 244 or responsive routing module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

Autonomous vehicle operation is broadly structured on three pillars: 1) perception, 2) maps/localization, and 3) behaviors planning and control. The mission of perception, which may be implemented at least in part by perception and understanding module 236, is to sense an environment (e.g., environment 150) surrounding the autonomous vehicle (e.g., autonomous vehicle 100) and interpret it. To interpret the surrounding environment 150, perception and understanding module 236 may identify and classify objects or groups of objects in environment 150. For example, autonomy computing system 200 may use perception and understanding module 236 to identify one or more objects (e.g., pedestrians, vehicles, animals/wildlife, debris, etc.) in the road before autonomous vehicle 100 and classify the objects in the road as distinct from the road.

The mission of maps/localization, which may be implemented at least in part by mapping module 232, is to figure out where in the world, or where on a pre-built map, is autonomous vehicle 100. One way to do this is to sense environment 150 surrounding autonomous vehicle 100 (e.g., via sensors 202) and to correlate features of the sensed environment with details (e.g., digital representations of the features of the sensed environment) on a digital map. Localizations can be expressed in various forms based on the medium in which they may be expressed. For example, autonomous vehicle 100 could be globally localized using a global positioning reference frame, such as latitude and longitude. The relative location of autonomous vehicle 100 with respect to one or more objects or features in the surrounding environment 150 could then be determined with knowledge of autonomous vehicle 100's global location and the knowledge of the one or more object or feature's global location(s). Alternatively, autonomous vehicle 100 could be localized with respect to one or more features directly. To do so, autonomous vehicle 100 may identify and classify one or more objects or features in environment 150 and may do this using, for example, sensors 202 and mapping module 232. Once the systems on autonomous vehicle 100 have determined its location with respect to the map features (e.g., intersections, road signs, etc.), autonomous vehicle 100 can plan maneuvers and/or routes with respect to the features of environment 150.

The mission of behaviors, planning, and control, which may be implemented at least in part by behaviors and planning module 238 and control module 240, is to make decisions about how autonomous vehicle 100 should move through environment 150 to get to its goal or destination. These modules consume information from perception and understanding module 236 and mapping module 232 to know where autonomous vehicle 100 is relative to the surrounding environment 150 and what other traffic actors are doing.

Environments intended for use by vehicles, whether such vehicles include autonomous features or not, tend to be pattern rich. That is, these environments are structured according to a pattern(s) that is recognizable by human drivers and increasingly by autonomous systems (e.g., all stop signs use same shape/color, all stop lights are green/yellow/red, etc.) The patterns enable and, indeed, may require predictable behavior by the operators of the vehicles in the environment, whether human or machine. Some of these patterns are related to infrastructure, which is generally designed according to certain rules, such as roads and streets having lanes defined by lane indications. Infrastructure is understood to be relatively stagnant, in that the design of a road or the placement of a turn lane, curb, or building does not change frequently or rapidly. Other patterns relate to contemporaneous and ephemeral behaviors or circumstances, such as the movement of pedestrians or wildlife. Even these changing behaviors may still be generalized or quantified based on repetitive patterns, such as the increase of pedestrian traffic on certain days or certain times of day, the appearance of certain animals in specific locations or at certain times of day, and the like.

In the example embodiment, behavior and understanding module 238 includes modeling module 244 for modeling these patterns in environments 150 of autonomous vehicles 100 (although, in some embodiments, perception and understanding module 236, or any other module of autonomy computing system, may include modeling module 244). A plurality of autonomous vehicles 100, such as a fleet of vehicles 100, capture sensor data (via sensors 202) continuously as they are controlled and operate along travel routes. Modeling module 244 takes this sensor data, particularly image or video data, to build training datasets, and generates and trains a plurality of machine learning models using these training datasets. The training datasets may include, for example, images or video of infrastructure around vehicles 100, images or video of other vehicles operating on a roadway including one or more lane boundaries or lane features (e.g., a lane boundary line, a right roadway shoulder edge, etc.), images or video of pedestrians or persons traveling using alternative vehicles (e.g., bicycles, scooters, golf carts, etc.), images or video of wildlife in environment(s) 150, and the like. These training datasets therefore include historical image or video data captured by the plurality of autonomous vehicles 100 over time.

The images or video in the training datasets may be annotated using one or more of the known or future data annotation techniques, to train any one or more of the known or future model types, such as image classifiers, video classifiers, image segmentation, object detection, object direction, instance segmentation, semantic segmentation, volumetric segmentation, composite objects, keypoint detection, keypoint mapping, 2-Dimension/3-Dimension and 6 degrees-of-freedom object poses, pose estimation, regressor networks, ellipsoid regression, 3D cuboid estimation, optical character recognition, text detection, and/or artifact detection. The trained machine learning models may include convolutional neural networks (CNNs), support vector machines (SVMs), generative adversarial networks (GANs), and/or other similar types of models that are trained using supervised, unsupervised, and/or reinforcement learning techniques. For example, as used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning system or model may be trained using one or more training dataset(s) that are fed into the system in order to establish, tune, or modify one or more aspects of the system, such as the weights, biases, criteria for forming classifications or clusters, or the like. The trained machine learning models may be stored by autonomy computing system 200 to allow subsequent retrieval and use by the system 200, for example, when incoming image or video signals are received from autonomous vehicle 100 (or other such vehicles 100 in a fleet) for processing.

In the context of the present disclosure, the trained machine learning models include associations between historical image or video data and the conditions or characteristics of environment 150 surrounding autonomous vehicles 100. That is, the trained machine learning models classify or characterize typical, expected, or standard conditions experienced by autonomous vehicles 100, as they relate to the infrastructure and environment 150 surrounding vehicles 100, including the behavior of other persons, vehicles, or animals in the environment. As such, the trained machine learning models are also configured to identify anomalous inputs, as inputs that cannot be classified, for example.

Additionally, in the example embodiment, mapping/localization module 232 maintains HD maps 250, which localize and map associations from modelling module 244 onto one or more mapping layers used for control of autonomous vehicle 100. More specifically, mapping module 232 generates HD maps 250 with one or more raster layers, including data categorizing or otherwise identifying typical or standard conditions associated with corresponding grid locations within the layers.

Layer monitoring module 242 leverages the trained machine learning models generated by modelling module 244 to monitor real-time, current, or otherwise incoming sensor data relative to the typical or standard conditions. For example, layer monitoring module 242 is configured to execute the trained machine learning modules on inputs that include real-time image or video data (or other sensor data captured by sensors 202) received from autonomous vehicle 100. Layer monitoring module 242 detects output from the trained machine learning module that is unclassified or output that deviates from the typical, expected, or standard outputs for a given location on an HD map layer. These outputs are collectively referred to as anomalous outputs, which relate to anomalous conditions, such as conditions around vehicle 100 that cannot be classified or that reach some threshold level of difference from the typical, expected, or standard conditions. Anomalous conditions-which may be referred to as incidents—are related to differences experiences in the actual location of vehicle 100 at some current time or subject time, as captured by sensors 202 of vehicle 100, from historical experiences.

In some instances, an anomalous condition or incident is detected (e.g., by layer monitoring module 242) based a model output that is a threshold magnitude of difference from a standard output, a threshold percentage difference from a standard output, one or more standard deviations from a standard output, or a different classification than a standard output. For example, layer monitoring module 242 compares the output from the trained machine learning models—based on input image, video, or other sensor data capture at vehicle 100 at a location—to the standard conditions for that location. Stated differently, layer monitoring module 242 detects a difference in environment 150 surrounding autonomous vehicle 100 from historical experiences of that environment 150, based on anomalous or different module outputs from modelling module 244.

When layer monitoring module 242 detects a difference or an anomalous condition, layer monitoring module 242 makes a record of this incident. In some cases, layer monitoring module 242 generates and stores a record of this incident as one instance related to a location on the corresponding map layer. That is, the incident records may be as simple as a “tally” or increment of a detected difference related to (e.g., indexed by) a location on a grid. Each record associates the incident with the location at which it was captured, based on the sensor data captured in real time by sensors 202. As such, the records are indexed according to their relative grid location on a corresponding layer of HD map(s) 250.

In some embodiments, each record also associates the incident with the time at which it was captured, based on the sensor data captured in real time by sensors 202. For example, layer monitoring module 242 identifies a timestamp within the sensor data that was input to modelling module 244 and associated with the detected incident. The incident record may include the timestamp or some other representative of the time. As such, the records may be further indexed according to their relative detection time. In some embodiments, layer monitoring module 242 also stores a characterization or representation of the incident in the record. For example, where a detected difference includes a different kind of wildlife detected in a location or a newly detected element of infrastructure, layer monitoring module 242 may write the record to include the type of incident. In some further embodiments, layer monitoring module 242 may characterize an incident according to a magnitude of the difference detected. For example, a significant difference in infrastructure (e.g., new billboard, a new lighting system, a broken bridge) may be categorized differently than a more minor difference in infrastructure (e.g., a broken fire hydrant, an additional speed limit sign along a route, a pothole). As such, the records may be indexed or categorized according to the type of incident or magnitude of difference detected.

Layer monitoring module 242 is further configured to monitor the incident records across a map layer for one or more adjustment criteria. The adjustment criteria may include, for example, a number of records indexed to a same location within a period of time exceeding a threshold number, a number of incidents exceeding a threshold magnitude, a type of incident, etc. The adjustment criteria may vary based on the type of incident, and may be defined to reflect the amount of impact the detected change would have on vehicles 100 operating along that location. As one example, an adjustment criterion including a threshold change in pedestrian traffic above some specific number of incidents or percentage change from a typical amount may be different for different grid locations on a same map layer. In some cases, one or more of the adjustment criteria has a rolling period of time associated therewith. For example, one or more records may be considered “stale” after one month, six months, or a year, and therefore may not be considered for comparison to the adjustment criteria.

In response to layer monitoring module 242 determining that any grid location satisfies the defined adjustment criteria, autonomy computing system 200 is configured to take one or more remedial actions. More specifically, responsive routing module 246 is configured to process the output(s) from layer monitoring module 242 and determine one or more remedial actions to initiate. In the example embodiment, responsive routing module 246 operates automatically based on the output from layer monitoring module 242 and initiates the remedial action(s) automatically, or without further input from any operator.

In some instances, responsive routing module 246 is configured to notify all vehicles 100 that are routed through that location. Responsive routing module 246 transmits a notification to autonomous vehicles 100 that operate using the map layer in which the adjustment criteria was met (e.g., using one or more external interfaces 206). In this way, the respective autonomy computing system 200 of each vehicle 100 (e.g., responsive routing modules 246 thereof) receives and processes the notification appropriately. The notification may be implemented as a flag or alert that is processed or activated upon arrival to the location or within some threshold distance of the location. Additionally or alternatively, the flag or alert is processed or activated upon receipt at the respective vehicles 100.

Upon activation, the flag or alert causes the respective responsive routing module 246 on an individual vehicle 100 to the alert and change the behavior of the vehicle. For example, responsive routing module 246 adjusts the rate of capture and/or processing of sensor data in the location such that the respective vehicle 100 can respond more quickly to what has been identified as a higher likelihood of some incident. As another example, responsive routing module 246 causes the respective autonomous vehicle 100 to change the lane of travel of autonomous vehicle 100 or to change its speed of travel.

In some instances, responsive routing module 246 changes the models utilized by modelling module 244. For example, responsive routing module 246 feeds new information back into the machine learning models as additional training data to accommodate the “new normal” at the respective location that meets the adjustment criteria. In this way, the trained machine learning models provide a more accurate reflection of the “on the ground” situation, because the model(s) has/have been trained to expect, for example, a different type of wildlife or a different frequency of encountering that wildlife, or a different frequency of encountering pedestrians or other persons, or at a different location or circumstance than previously associated with that location. This re-training results in fewer incidents being detected by layer monitoring module 242, improving the feedback loop.

In some instances, responsive routing module 246 transmits instructions to mapping module 232 to update HD maps 250. The instructions could include instructions to include the flag/alert as described above, or to make a particular change to the corresponding grid location in the raster layer, to reflect the “new normal.” The updated maps 250 are stored and transmitted to all other vehicles 100 utilizing the corresponding map layer. Therefore, each vehicle 100 utilizing the same HD maps 250 may interpret the new map layer and adjust control of vehicle 100 individually. In some embodiments, the new or updated HD maps 250 cause a change in the control operations of vehicles 100 passing through the location. That is, the routing of vehicles 100 by autonomy computing systems 200 will change to avoid the location, control vehicles 100 to travel through the location under a more limited set of circumstances than previously, or change operation of all vehicles 100 being routed through the location.

In some instances, responsive routing module 246 communicates with one or more third-party systems and notifies the third-party system(s) of the anomalous condition(s) being detected. For example, autonomy computing system 200 identifies a third-party system associated with the location at which the adjustment criteria were met, such as a governmental entity, a first responder entity, etc. Responsive routing module 246 is configured to transmit an alert message (e.g., using one or more external interfaces 206) that identifies the location of the anomalous conditions as well as the nature of the conditions (e.g., the type, magnitude, or number of incidents detected). The alert message may also include a recommended response, such as the installation of additional signage, repair or replacement of an element of infrastructure, the introduction of additional infrastructure (e.g., an additional pedestrian crossing), and the like.

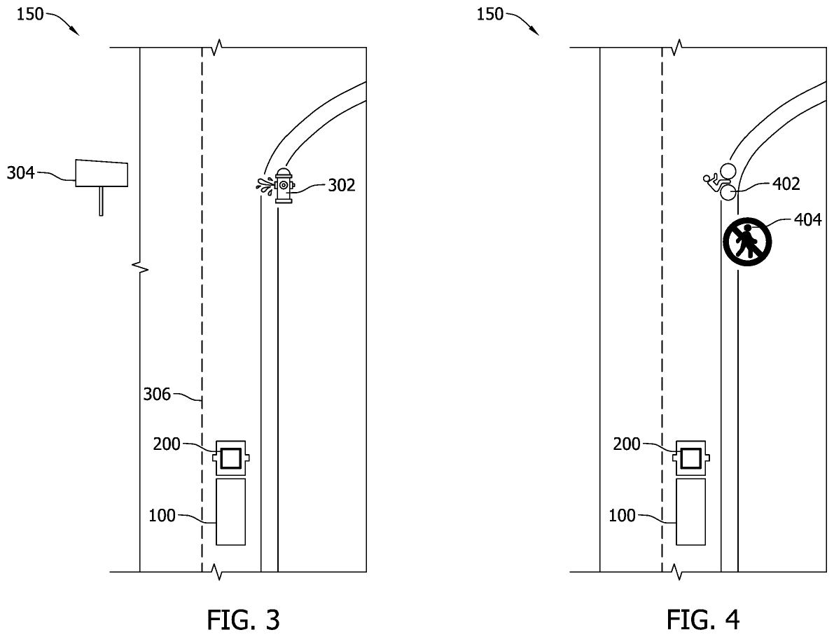

Turning to FIGS. 3-5, example environments 150 surrounding or encountered by autonomous vehicles 100 are depicted.

In FIG. 3, environment 150 includes a new infrastructure element 304, illustrated as a newly installed billboard, as well as an existing infrastructure element 306, illustrated as a lane indicator on the road. Autonomy computing system 200 processes the inputs from sensors 202 (shown in FIG. 2). Specifically, the sensor data captured by sensors 202 is fed through modelling module 244, and the output from modelling module 244 is interpreted by layer monitoring module 242 based on stored HD maps 250 (all shown in FIG. 2). Layer monitoring module 242, in this instance, may detect no incident, because the presence of new infrastructure element 304 does not meet a significance threshold, and existing infrastructure element 306 is suitably classified.

Environment 150 of FIG. 3 also includes a changed infrastructure element 302, which may be more broadly referred to as a change in condition or different condition. In particular, a fire hydrant is broken and spraying water onto the roadway, which can affect safe operation of vehicle 100. The output from modelling module 244 may indicate a change in environment 150 relative to historical experiences of environment 150, based on changed infrastructure element 302. Additionally or alternatively, the output from modelling module 244 may classify changed infrastructure element 302 as a broken fire hydrant, as water on the roadway, etc. Layer monitoring module 242 may process the output from modelling module 244 and, in response, generate and store a record of the incident at that location, as represented on a map layer. If the incident causes that location to meet one or more adjustment criteria (e.g., a same incident has been detected and recorded a threshold number of times), responsive routing module 246 (shown in FIG. 2) may take one or more remedial actions. For example, responsive routing module 246 may cause vehicle 100 to travel at a reduced speed or travel in a different lane. Additionally, responsive routing module 246 may generate and transmit a notification to a third-party system regarding the detected state of the infrastructure element 302. For example, responsive routing module 246 may transmit a notification to a governmental authority associated with the location of environment 150, the notification identifying the broken fire hydrant and, in some cases, recommending repair.

With respect to FIG. 4, environment 150 includes an existing infrastructure element 404, illustrated as an existing sign indicating that pedestrians and bicyclists are not permitted on the roadway. However, environment 150 also includes a pedestrian or bicyclist 402. Autonomy computing system 200 processes the inputs from sensors 202 (shown in FIG. 2) of autonomous vehicle 100. Specifically, the sensor data captured by sensors 202 is fed through modelling module 244, and the output from modelling module 244 is interpreted by layer monitoring module 242 based on stored HD maps 250 (all shown in FIG. 2).

In this instance, the presence of pedestrian or bicyclist 402 is not standard or is unexpected at the location of environment 150, as indicated by output from modelling module 244. Layer monitoring module 242 may therefore detect and record an incident. As described above, the incident is associated with that particular location as represented on a map layer, and the incident may be classified as a pedestrian incident, which may automatically have a high level of significance. If the incident causes that location to meet one or more adjustment criteria (e.g., a same incident has been detected and recorded a threshold number of times, or the significance of the incident exceeds a threshold), responsive routing module 246 (shown in FIG. 2) may take one or more remedial actions. For example, responsive routing module 246 may cause vehicle 100 to travel at a reduced speed or travel in a different lane. Additionally, responsive routing module 246 may generate and transmit a notification to a third-party system regarding the detected pedestrian/bicyclist. For example, responsive routing module 246 may transmit a notification to a governmental authority associated with the location of environment 150, the notification identifying the incident and, in some cases, recommending additional or alternative infrastructure (e.g., more signs similar to infrastructure element 404, a marked or raised pedestrian crossing, etc.) or the presence of enforcement authorities to improve safety.

Turning to FIG. 5, environment 150 includes a non-standard animal or member of wildlife 502, illustrated as a bear. In this example, deer are expected or encountered at the location of environment 150, but, historically, bears are not. Autonomy computing system 200 processes the inputs from sensors 202 (shown in FIG. 2) of autonomous vehicle 100. Specifically, the sensor data captured by sensors 202 is fed through modelling module 244, and the output from modelling module 244 is interpreted by layer monitoring module 242 based on stored HD maps 250 (all shown in FIG. 2).

In this instance, the presence of non-standard wildlife 502 (e.g., the bear) is not standard or is unexpected at the location of environment 150, as indicated by output from modelling module 244. Layer monitoring module 242 may therefore detect and record an incident. As described above, the incident is associated with that particular location as represented on a map layer, and the incident may be classified as a wildlife incident. If the incident causes that location to meet one or more adjustment criteria (e.g., a same incident has been detected and recorded a threshold number of times, or the significance of the incident exceeds a threshold), responsive routing module 246 (shown in FIG. 2) may take one or more remedial actions. For example, responsive routing module 246 may cause vehicle 100 to travel at a reduced speed or travel in a different lane. Additionally, responsive routing module 246 may generate a flag to append to a layer of HD maps 250 or may cause HD maps 250 to update, to reflect the “new normal” that, in this example, bears are more frequently encountered within environment 150. In some cases, data related to wildlife incidents may be shared with one or more third-party systems that monitor the presence or movement of wildlife within an area.

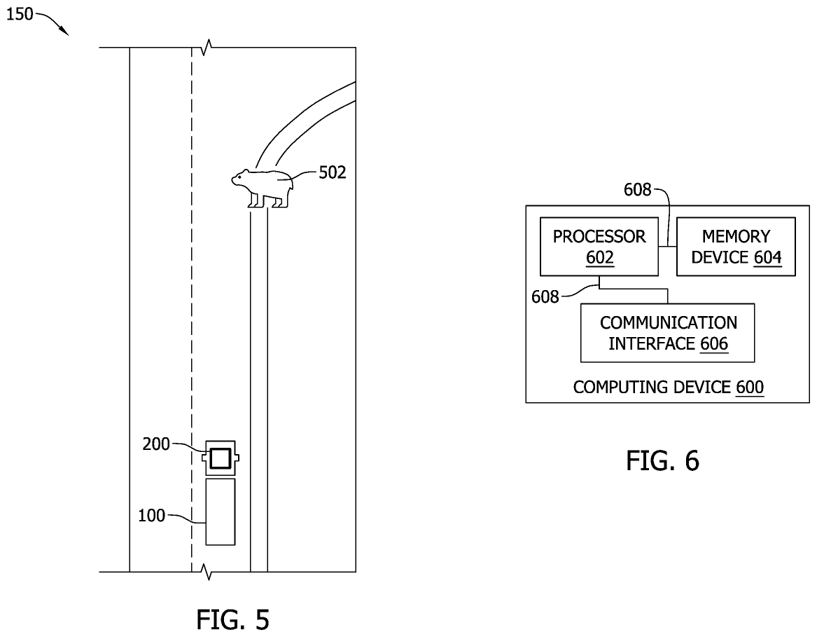

FIG. 6 is a block diagram of an example computing device 600. Computing device 600 includes a processor 602 and a memory device 604. The processor 602 is coupled to the memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 604 includes one or more devices that enable information, such as executable instructions or other data (e.g., sensor data, models, HD maps), to be stored and retrieved. Moreover, the memory device 604 includes one or more computer readable media, such as, without limitation, dynamic random-access memory (DRAM), static random-access memory (SRAM), a solid-state disk, or a hard disk. In the example embodiment, the memory device 604 stores, without limitation, application source code, application object code, configuration data, additional input events, application states, assertion statements, validation results, or any other type of data. The computing device 600, in the example embodiment, may also include a communication interface 606 that is coupled to the processor 602 via system bus 608. Moreover, the communication interface 606 is communicatively coupled to data acquisition devices.

In the example embodiment, processor 602 may be programmed by encoding an operation using one or more executable instructions and providing the executable instructions in the memory device 604. In the example embodiment, the processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

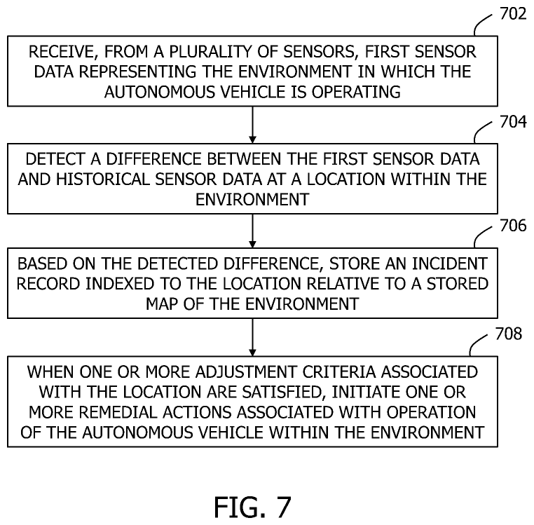

FIG. 7 is a flow diagram of an example method 700 of infrastructure and environmental mapping and vehicle behavior modification. Method 700 may be implemented using autonomy system 200 (shown in FIG. 2) of autonomous vehicle 100 (shown in FIG. 1).

In one example embodiment, method 700 includes receiving 702, from a plurality of sensors of the autonomous vehicle, first sensor data representing the environment in which the autonomous vehicle is operating at a first time. The first sensor data includes image or video data. Method 700 also includes detecting 704 a difference between the first sensor data and historical sensor data at a location within the environment, the historical sensor data captured within the environment over a preceding period of time.

Method 700 further includes storing 706 an incident record in the memory, based on the detected difference, the incident record indexed to the location relative to a stored map of the environment. Method 700 still further includes, when one or more adjustment criteria associated with the location are satisfied, initiating 708 one or more remedial actions associated with operation of the autonomous vehicle within the environment.

Method 700 may include additional, fewer, or alternative steps.

For example, in some embodiments, detecting 704 includes executing a trained machine learning model using the first sensor data as input, and processing output from the trained machine learning model. Method 700 may also include training the trained machine learning model on a training dataset including the historical sensor data. In some instances, initiating 708 includes re-training the trained machine learning model using the incident record.

In some embodiments, method 700 also includes localizing the detected difference relative to the stored map of the environment, and generating the incident record including the localization.

In some instances, method 700 also includes identifying a timestamp in the first sensor data associated with the detected difference, and storing the incident record including the timestamp.

In some embodiments, initiating 708 includes updating the stored map of the environment, and method 700 also includes transmitting the updated map to a plurality of other autonomous vehicles operating in the environment.

In still other embodiments, initiation 708 includes changing operation of the autonomous vehicle within the environment.

An example technical effect of the methods, systems, and apparatus described herein includes at least one of: (a) robust and precise monitoring of changes in environments used by autonomous vehicles for localization or routing, (b) improved responsiveness to such changes in the operation of autonomous vehicles in such environments, and (c) facilitating notification of environmental changes to relevant third parties to initiate changes and improve safety.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for infrastructure and environmental mapping and automated vehicle behavior modification, the system comprising:
a plurality of sensors of an autonomous vehicle, the plurality of sensors configured to capture sensor data representing an environment in which the autonomous vehicle is operating; and
an autonomy computing system comprising a processor and a memory, the processor programmed to:
receive, from the plurality of sensors, first sensor data representing the environment in which the autonomous vehicle is operating at a first time, the first sensor data including image or video data;
detect a difference between the first sensor data and historical sensor data at a location within the environment, the historical sensor data captured within the environment over a preceding period of time;
based on the detected difference, store, in the memory, an incident record indexed to the location relative to a stored map of the environment; and
when one or more adjustment criteria associated with the location are satisfied, initiate one or more remedial actions associated with operation of the autonomous vehicle within the environment.

2. The system of claim 1, wherein the processor is further programmed to detect the difference by:
executing a trained machine learning model using the first sensor data as input; and
processing output from the trained machine learning model.

3. The system of claim 2, wherein the processor is further programmed to train the trained machine learning model on a training dataset including the historical sensor data.

4. The system of claim 2, wherein the processor is further programmed to initiate the remedial action by:
re-training the trained machine learning model using the incident record.

5. The system of claim 1, wherein the processor is further programmed to:
localize the detected difference relative to the stored map of the environment; and
generate the incident record including the localization.

6. The system of claim 1, wherein the processor is further programmed to:
identify a timestamp in the first sensor data associated with the detected difference; and
store the incident record including the timestamp.

7. The system of claim 1, wherein the one or more adjustment criteria include one of a number of incidents relative to the location, a type of incident relative to the location, or a magnitude of incident relative to the location.

8. The system of claim 1, wherein the processor is further programmed to initiate the remedial action by:
updating the stored map of the environment.

9. The system of claim 8, wherein the processor is further programmed to transmit the updated map to a plurality of other autonomous vehicles operating in the environment.

10. The system of claim 1, wherein the processor is further programmed to initiate the remedial action by:
changing operation of the autonomous vehicle within the environment.

11. The system of claim 10, wherein the operation includes one of a route, a speed, and a lane selection.

12. A computer-implemented method for infrastructure and environmental mapping and autonomous vehicle behavior modification, the method implemented by an autonomy computing system of an autonomous vehicle, the autonomy system including a processor and a memory, the method comprising:
receiving, from a plurality of sensors of the autonomous vehicle, first sensor data representing an environment in which the autonomous vehicle is operating at a first time, the first sensor data including image or video data;
detecting a difference between the first sensor data and historical sensor data at a location within the environment, the historical sensor data captured within the environment over a preceding period of time;
based on the detected difference, storing, in the memory, an incident record indexed to the location relative to a stored map of the environment; and
when one or more adjustment criteria associated with the location are satisfied, initiating one or more remedial actions associated with operation of the autonomous vehicle within the environment.

13. The method of claim 12, wherein detecting the difference comprises:
executing a trained machine learning model using the first sensor data as input; and
processing output from the trained machine learning model.

14. The method of claim 13, further comprising training the trained machine learning model on a training dataset including the historical sensor data.

15. The method of claim 13, wherein initiating the remedial action comprises re-training the trained machine learning model using the incident record.

16. The method of claim 12, further comprising:
localizing the detected difference relative to the stored map of the environment; and
generating the incident record including the localization.

17. The method of claim 12, further comprising:
identifying a timestamp in the first sensor data associated with the detected difference; and
storing the incident record including the timestamp.

18. The method of claim 12, wherein initiating the remedial action comprises:
updating the stored map of the environment; and
transmitting the updated map to a plurality of other autonomous vehicles operating in the environment.

19. The method of claim 12, wherein initiating the remedial action comprises changing operation of the autonomous vehicle within the environment.

20. An autonomous vehicle comprising:
a plurality of sensors configured to capture sensor data representing an environment in which the autonomous vehicle is operating; and
an autonomy computing system comprising a processor and a memory, the processor programmed to:
receive, from the plurality of sensors, first sensor data representing the environment in which the autonomous vehicle is operating at a first time, the first sensor data including image or video data;
detect a difference between the first sensor data and historical sensor data at a location within the environment, the historical sensor data captured within the environment over a preceding period of time;
based on the detected difference, store, in the memory, an incident record indexed to the location relative to a stored map of the environment; and
when one or more adjustment criteria associated with the location are satisfied, initiate one or more remedial actions associated with operation of the autonomous vehicle within the environment.
